(19) United States
(12) Patent Application Publication
(10) Pub. No.: US 2014/0219116 A1
(43) Pub. Date: Aug. 7, 2014

(54) MOBILE COMMUNICATION METHOD, CORE NETWORK DEVICE, RADIO BASE STATION AND MOBILE STATION

(71) Applicants: Mikio Iwamura, Chiyoda-ku (JP); Hideaki Takahashi, Chiyoda-ku (JP)

(72) Inventors: Mikio Iwamura, Chiyoda-ku (JP); Hideaki Takahashi, Chiyoda-ku (JP)

(73) Assignee: NTT DOCOMO, INC., Tokyo (JP)

(21) Appl. No.: 14/009,191

(22) PCT Filed: Mar. 27, 2012
(86) PCT No.: PCT/JP2012/057985

§ 371 Date: Oct. 1, 2013

(30) Foreign Application Priority Data
Apr. 1, 2011 (JP) 2011-082200

(51) Int. Cl. H04W 24/10; H04L 5/00

(52) U.S. Cl. CPC H04W 24/10; H04L 5/0051
USPC 370/252

(57) ABSTRACT

A mobile communication method according to the present invention includes: a step in which a core network device CN transmits a predetermined notification signal to a radio base station eNB when mobile stations UE#1/UE#2 are connected to a cell under a dominant of the identical radio base station eNB; a step in which the radio base station eNB transmits a request signal to the mobile stations UE#1/UE#2 to measure radio communication quality between the mobile stations UE#1/UE#2 in response to the predetermined notification signal; a step in which the mobile stations UE#1/UE#2 transmit RS#1/RS#2 to the mobile stations UE#2/UE#1 in response to the request signal; a step in which the mobile station UE#1 transmits a measurement result of the RS#2 to the radio base station eNB; and a step in which the mobile station UE#2 transmits a measurement result of the RS#1 to the radio base station eNB.

### TECHNICAL FIELD

The present invention relates to a mobile communication method, a core network device, a radio base station and a mobile station.

### BACKGROUND ART

In cellular mobile communication systems such as a W-CDMA (Wideband-Code Division Multiple Access) system and an LTE (Long Term Evolution) system, plural mobile stations UE are configured to conduct communication with each other through a radio access network device, a core network device or the like.

### CITATION LIST

### Non-Patent Literature

Non-Patent Literature 1: 3GPP TS36.300

However, in the conventional cellular mobile communication system, even if the plural mobile stations UE are located in an identical cell (or a cell under a domination of the radio access network device), unfortunately a process load on the radio access network device increases because both a data signal and a control signal are configured to transmitted and received through the radio access network device.

The present invention has been devised to solve the problems described above, and an object thereof is to provide a mobile communication method, a core network device, a radio base station and a mobile station for being able to make a transition to a state in which the data signal is transmitted and received without a radio base station between the plural mobile stations from a state in which the data signal is transmitted and received through the radio base station.

### SUMMARY OF THE INVENTION

In accordance with a first feature of the present invention, a mobile communication method includes: a step in which a core network device transmits a predetermined notification signal to a radio base station when a first mobile station and a second mobile station are connected to a cell under a dominant of the identical radio base station; a step in which the radio base station transmits a request signal to the first mobile station and the second mobile station to measure radio communication quality between the first mobile station and the second mobile station in response to the predetermined notification signal; a step in which the first mobile station transmits a first reference signal to the second mobile station in response to the request signal; a step in which the second mobile station transmits a second reference signal to the first mobile station in response to the request signal; a step in which the first mobile station transmits a measurement result of the second reference signal to the radio base station; and a step in which the second mobile station transmits a measurement result of the first reference signal to the radio base station.

In accordance with a second feature of the present invention, a core network device to which a radio base station is connected under a dominant thereof, the core network device includes: a determination unit that is configured to determine whether a first mobile station and a second mobile station are connected to a cell under a dominant of the radio base station when service request signals are received from the first mobile station and the second mobile station; a transmission unit that is configured to transmit a predetermined notification signal to the radio base station when the determination unit determines that the first mobile station and the second mobile station are connected to the cell under the dominant of the radio base station; and a reception unit that is configured to receive a signal from the radio base station, the signal indicating that the first mobile station and the second mobile station start to transmit and receive the data signal without the radio base station.

In accordance with a third feature of the present invention, a radio base station that is connected under a dominant of a core network device, the radio base station includes: a reception unit that is configured to receive a predetermined notification signal, which makes a notification that a first mobile station and a second mobile station are connected to a cell under a dominant of the radio base station, from the core network device; and a transmission unit that is configured to transmits a request signal to the first mobile station and the second mobile station to measure radio communication quality between the first mobile station and the second mobile station when the predetermined notification signal is received, wherein the reception unit is configured to receive a measurement result of a second reference signal from the first mobile station, and to receive a measurement result of a first reference signal from the second mobile station, the transmission unit is configured to notify the core network device that the first mobile station and the second mobile station start to transmit and receive a data signal without the radio base station, the first reference signal is a reference signal that is transmitted to the second mobile station by the first mobile station, and the second reference signal is a reference signal that is transmitted to the first mobile station by the second mobile station.

In accordance with a fourth feature of the present invention, a mobile station includes: a reception unit that is configured to receive a request signal from a radio base station to measure radio communication quality between the mobile station and the other mobile station when the mobile station is connected to a cell under a dominant of the radio base station connected under a dominant of a core network device; a measurement unit that is configured to perform a measurement process to a reference signal transmitted by the other mobile station in response to the request signal; and a transmission unit that is configured to transmit a measurement result of the reference signal to the radio base station, wherein the transmission unit and the reception unit are configured to start to transmit and receive a data signal to and from the other mobile station without the radio base station in response to an instruction signal from the radio base station.

As described above, the present invention can provide a mobile communication method for being able to make a transition to a state in which a data signal is transmitted and received without a radio base station between plural mobile stations from a state in which the data signal is transmitted and received through the radio base station, a core network device, a radio base station, and a mobile station.

### BRIEF DESCRIPTION OF DRAWINGS

FIG. 1 is an entire configuration diagram of a mobile communication system according to a first embodiment of the present invention.

FIG. 2 is a functional block diagram of a core network device according to the first embodiment of the present invention.

FIG. 3 is a functional block diagram of a radio base station according to the first embodiment of the present invention.

FIG. 4 is a functional block diagram of a mobile station according to the first embodiment of the present invention.

FIG. 5 is a sequence diagram illustrating operation of the mobile communication system according to the first embodiment of the present invention.

### DESCRIPTION OF EMBODIMENTS

(Mobile Communication System of First Embodiment of the Present Invention)

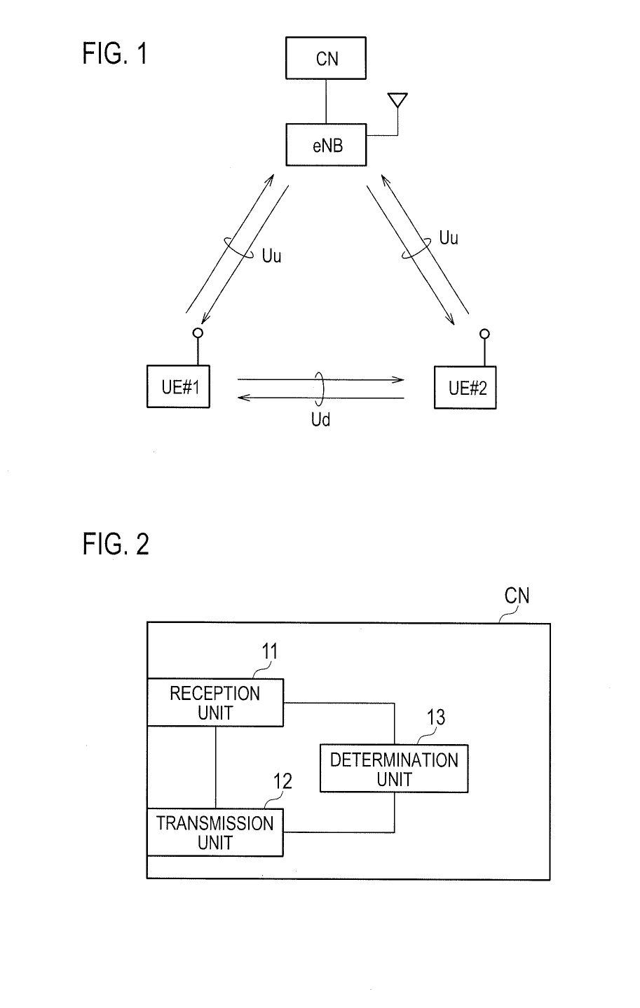

A mobile communication system according to a first embodiment of the present invention will be described with reference to FIGS. 1 to 5.

The mobile communication system of the embodiment is an LTE mobile communication system, and includes a core network device CN and a radio base station eNB that is connected under a domination of the core network device CN as illustrated in FIG. 1. The present invention can also be applied to a cellar mobile communication system except the LTE mobile communication system.

The radio base station eNB and mobile stations UE#1/UE#2 are configured to transmit and receive data each other through an Uu interface, and the mobile station UE#1 and the mobile station UE#2 are configured to transmit and receive data each other through an Ud interface.

That is, the mobile station UE#1 can transmit and receive a data signal to and from the mobile station UE#2 through the radio base station eNB (through the Uu interface), or transmit and receive the data signal to and from the mobile station UE#2 not through the radio base station eNB (but through the Ud interface).

The core network device CN is a device in a core network that accommodates a radio access network. For example, the core network device CN may be a mobile management node MME (Mobility Management Entity) or a gateway device P/S-GW (PDN/Serving-Gateway).

As illustrated in FIG. 2, the core network device CN includes a reception unit 11, a transmission unit 12, and a determination unit 13.

The reception unit 11 is configured to receive an SlAP message from the radio base station eNB, and to receive an NAS (Non Access Stratum) message from the mobile stations UE#1/UE#2.

For example, the reception unit 11 is configured to receive “Service Request” from the mobile stations UE#1/UE#2 in “Service Request Procedure”.

The reception unit 11 is configured to receive a signal, which indicates that the mobile stations UE#1/UE#2 start to transmit and receive the data signal without the radio base station eNB, from the radio base station eNB.

The transmission unit 12 is configured to transmit the SlAP message to the radio base station eNB, and to transmit the NAS message to the mobile stations UE#1/UE#2.

The determination unit 13 is configured to determine whether the mobile stations UE#1/UE#2 are connected to a cell under a dominant of the radio base station eNB when “Service Request” is received from the mobile stations UE#1/UE#2.

The transmission unit 12 is configured to transmit a predetermined notification signal to the radio base station eNB when the determination unit 13 determines that the mobile stations UE#1/UE#2 are connected to the cell under the dominant of the radio base station eNB.

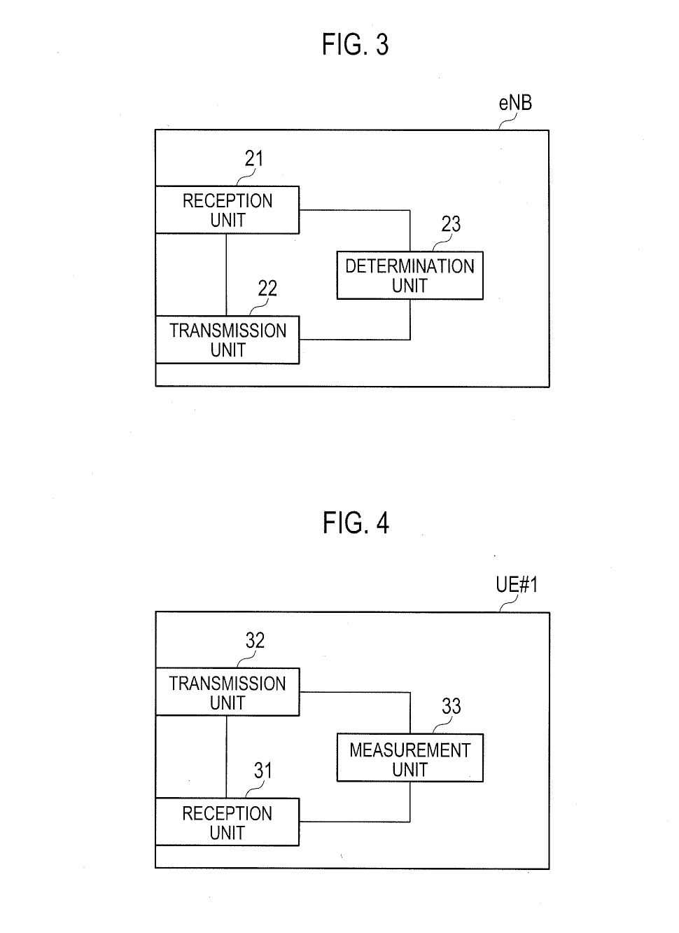

As illustrated in FIG. 3, the radio base station eNB includes a reception unit 21, a transmission unit 22, and a determination unit 23.

The reception unit 21 is configured to receive the SlAP message from the core network device CN, and to receive an AS (Access Stratum) message or an RRC (Radio Resource Control) message from the mobile stations UE#1/UE#2.

For example, the reception unit 21 is configured to receive the predetermined notification signal, which makes a notification that the mobile stations UE#1/UE#2 are connected to the cell under the dominant of the radio base station eNB, from the core network device CN.

The reception unit 21 is configured to receive a measurement result of an RS (Reference Signal) #2 from the mobile station UE#1, and to receive a measurement result of an RS#1 from the mobile station UE#2.

As used herein, the RS#1 is a reference signal transmitted to the mobile station UE#2 by the mobile station UE#1, and the RS#2 is a reference signal transmitted to the mobile station UE#1 by the mobile station UE#2.

The transmission unit 22 is configured to transmit the S1AP message to the core network device CN, and to transmit the AS message or the RRC message to the mobile stations UE#1/UE#2.

For example, the transmission unit 22 is configured to transmit a request signal to the mobile stations UE#1/UE#2 to measure radio communication quality between the mobile stations UE#1/UE#2 when the reception unit 21 receives the predetermined notification signal.

The transmission unit 22 is configured to transmit setting information on the RS#1 that should be transmitted or setting information on the RS#2 that should be measured to the mobile station UE#1, and to transmit setting information on the RS#2 that should be transmitted or setting information on the RS#1 that should be measured to the mobile station UE#2. The setting information may include, for example, use frequency information, time information, code information, or cycle information of the RS#1 or RS#2.

The determination unit 23 may be configured to determine whether the transmission unit 22 should transmit the request signal to measure the radio communication quality between the mobile stations UE#1/UE#2.

For example, the determination unit 23 is configured to determine that the request signal is not transmitted when the mobile stations UE#1/UE#2 are connected to a different cell under the dominant of the radio base station eNB.

In this case, the transmission unit 22 is configured to transmit a failure response to the core network device CN in response to the predetermined notification signal received by the reception unit 21.

The transmission unit 22 is configured to transmit the failure response to the core network device CN in response to the predetermined notification signal received by the reception unit 21, when “Ud switching procedure” is not performed or when the mobile stations UE#1/UE#2 fail in “Ud switching procedure”.

The determination unit 23 is configured to determine whether the mobile stations UE#1/UE#2 should perform a procedure to start to transmit and receive the data signal without the radio base station eNB, namely, “Ud switching procedure” after the reception unit 21 receives the measurement results of the RS#1/RS#2.

At this point, the determination unit 23 may be configured to determine that the mobile stations UE#1/UE#2 should perform the procedure to start to transmit and receive the data signal without the radio base station eNB, namely, “Ud switching procedure” when the measurement results of the RS#1/RS#2 satisfy a predetermined condition.

In this case, the transmission unit 22 is configured to notify the core network device CN that the mobile station UE#1 and the mobile station UE#2 start to transmit and receive the data signal without the radio base station eNB.

For example, the determination unit 23 may be configured to determine that the measurement results of the RS#1/RS#2 satisfy the predetermined condition, when the radio communication quality included in the measurement result of the RS#1 is greater than a first threshold and when the radio communication quality included in the measurement result of the RS#2 is greater than a second threshold.

The first threshold and the second threshold may be equal to or different from each other.

In the embodiment, because the configurations of the mobile station UE#1 and the mobile station UE#2 are basically identical to each other, the configuration of the mobile station UE#1 will representatively be described below. As illustrated in FIG. 4, the mobile station UE#1 includes a transmission unit 31, a reception unit 32, and a measurement unit 33.

The transmission unit 31 is configured to transmit the NAS message to the core network device CN, and to transmit the AS message or the RRC message to the radio base station eNB.

For example, the transmission unit 31 is configured to transmit “Measurement Report” including the measurement result of the RS#2 described below to the radio base station eNB.

The reception unit 32 is configured to receive the NAS message from the core network device CN, and to receive the AS message or the RRC message from the mobile stations UE#2.

For example, the reception unit 32 is configured to receive the request signal to measure the radio communication quality between the mobile stations UE#1/UE#2 from the radio base station eNB. The request signal may include the setting information on the RS#1 that should be transmitted by the mobile station UE#1 and the setting information on the RS#2 that should be measured by the mobile station UE#1.

The measurement unit 33 is configured to perform measurement (measurement process) to the RS#2 transmitted by the mobile station UE#2 in response to the request signal received by the reception unit 32.

For example, the measurement unit 33 is configured to measure the radio communication quality of the RS#2 such as RSRP (Reference Signal Received Power) of the RS#2 or RSRQ (Reference Signal Received Quality) of the RS#2, and CQI (Channel Quality Index) of the RS#2 in the measurement of the RS#2.

The transmission unit 31 and the reception unit 32 are configured to make a transition to a state in which the data signal is transmitted and received without the radio base station from a state in which the data signal is transmitted and received through the radio base station in response to an instruction signal from the radio base station eNB.

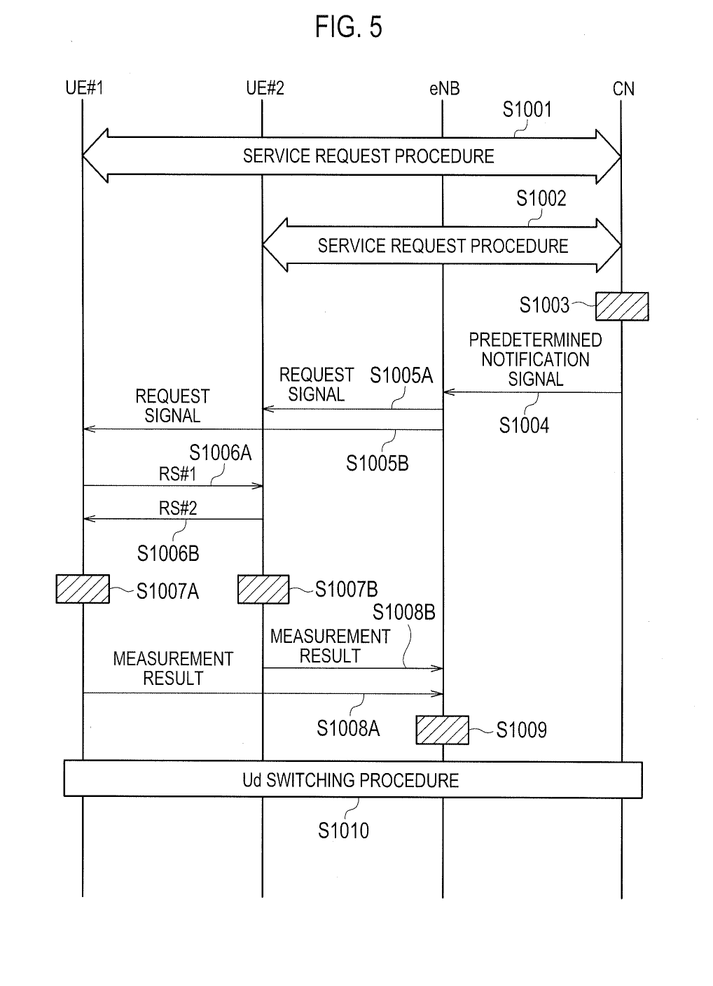

An example of operation of the mobile communication system of the embodiment will be described below with reference to FIG. 5.

In the mobile communication system of the embodiment, when the mobile station UE#1 and the mobile station UE#2 conduct communication with each other, as illustrated in FIG. 5, “Service Request Procedure” is performed between the mobile station UE#1 and the core network device CN in Step S1001, and “Service Request Procedure” is performed between the mobile station UE#2 and the core network device CN in Step S1002.

The core network device CN is configured to determine whether the mobile stations UE#1/UE#2 are connected to the cell under the dominant of the identical radio base station eNB in Step S1003.

When the mobile stations UE#1/UE#2 are connected to the cell under the dominant of the identical radio base station eNB, the core network device CN transmits the predetermined notification signal indicating that effect to the radio base station eNB in Step S1004.

The radio base station eNB transmits the request signal to the mobile station UE#1 to measure the radio communication quality between the mobile stations UE#1/UE#2 in Step S1005A, and transmits the request signal to the mobile station UE#2 to measure the radio communication quality between the mobile stations UE#1/UE#2 in Step S1005B.

The mobile station UE#1 transmits the RS#1 to the mobile station UE#2 in response to the request signal in Step S1006A, and the mobile station UE#2 transmits the RS#2 to the mobile station UE#1 in response to the request signal in Step S1006B.

The mobile station UE#1 performs the measurement to the RS#2 in Step S1007A, and the mobile station UE#2 performs the measurement to the RS#1 in Step S1007B.

The mobile station UE#1 notifies the radio base station eNB of the measurement result of the RS#2 in Step S1008A, and the mobile station UE#2 notifies the radio base station eNB of the measurement result of the RS#1 in Step S1008B.

At this point, the mobile stations UE#1/UE#2 notify the radio base station eNB of the measurement results of the RS#2/RS#1 by “Measurement Report” or another message.

In Step S1009, the radio base station eNB determines whether the mobile stations UE#1/UE#2 should perform the procedure to start to transmit and receive the data signal without the radio, base station eNB, namely, “Ud switching procedure” after the radio base station eNB receives the measurement results of the RS#1/RS#2.

For example, the radio base station eNB may determine that “Ud switching procedure” should be performed when the measurement results of the RS#1/RS#2 are determined to satisfy the predetermined condition.

As a result, the mobile station UE#1 and the mobile station UE#2 conduct communication with each other without the radio base station eNB (through the Ud interface). As a result, the core network device CN may put bearers of the mobile station UE#1 and the mobile station UE#2 into a preservation state (a hold state).

The determination in Step S1009 may be performed by not the radio base station eNB but the core network device CN.

On the other hand, when it is determined that the mobile stations UE#1/UE#2 are not connected to the cell under the dominant of the identical radio base station eNB in Step S1003, the mobile station UE#1 and the mobile station UE#2 conduct communication with each other through the radio base station eNB (through the Uu interface).

According to the mobile communication system of the first embodiment of the present invention, the mobile station UE#1 and the mobile station UE#2 can conduct communication with each other through not the radio base station eNB but the Ud interface when the mobile stations UE#1/UE#2 are connected to the cell under the dominant of the identical radio base station eNB and when the measurement results of the RS#1/RS#2 satisfy the predetermined condition.

In the first embodiment, “Service Request” acts as a trigger to perform the Ud switching procedure. Alternatively, another procedure may act as the trigger to similarly perform the Ud switching procedure. For example, addition or change of the bearer may act as the trigger to perform the Ud switching procedure.

Although only the case that the mobile station UE#1 and the mobile station UE#2 conduct communication with each other is described in the first embodiment, the mobile station UE#1 and the mobile station UE#2 may simultaneously conduct communication with another mobile station through the Ud interface.

Additionally, the mobile station UE#1 and the mobile station UE#2 may conduct communication through the Ud interface while simultaneously conducting communication with another peer entity through the Uu interface.

In such cases, the Ud interface may be set in each bearer. Particularly, the core network device CN may determine whether the Ud switching procedure is performed in each bearer.

The above features of the embodiment may be expressed as follows.

In the first feature of the embodiment, a mobile communication method includes: a step in which the core network device CN transmits the predetermined notification signal to the radio base station eNB when the mobile station UE#1 (the first mobile station) and the mobile station UE#2 (the second mobile station) are connected to the cell under the dominant of the identical radio base station eNB; a step in which the radio base station eNB transmits the request signal to the mobile station UE#1 and the mobile station UE#2 to measure the radio communication quality between the mobile station UE#1 and the mobile station UE#2 in response to the predetermined notification signal; a step in which the mobile station UE#1 transmits the RS#1 (the first reference signal) to the mobile station UE#2 in response to the request signal; a step in which the mobile station UE#2 transmits the RS#2 (the second reference signal) to the mobile station UE#1 in response to the request signal; a step in which the mobile station UE#1 transmits the measurement result of the RS#2 to the radio base station eNB; and a step in which the mobile station UE#2 transmits the measurement result of the RS#1 to the radio base station eNB.

In the first feature of the embodiment, the mobile communication method may further include a step in which the mobile station UE#1 and the mobile station UE#2 start to transmit and receive the data signal without the radio base station eNB after the measurement results of the RS#1 and the RS#2 are transmitted.

In the second feature of the embodiment, the core network device CN to which the radio base station eNB is connected under the dominant thereof, the core network device CN includes: the determination unit 13 that is configured to determine whether the mobile station UE#1 and the mobile station UE#2 are connected to the cell under the dominant of the radio base station eNB when “Service Request (the service request signals)” are received from the mobile station UE#1 and the mobile station UE#2; the transmission unit 12 that is configured to transmit the predetermined notification signal to the radio base station eNB when the determination unit 13 determines that the mobile station UE#1 and the mobile station UE#2 are connected to the cell under the dominant of the radio base station eNB; and the reception unit 11 that is configured to receive the signal from the radio base station eNB, the signal indicating that the mobile station UE#1 and the mobile station UE#2 start to transmit and receive the data signal without the radio base station eNB.

In the third feature of the embodiment, the radio base station eNB that is connected under the dominant of the core network device CN, the radio base station eNB includes: the reception unit 21 that is configured to receive the predetermined notification signal, which makes the notification that the mobile station UE#1 and the mobile station UE#2 are connected to the cell under the dominant of the radio base station eNB, from the core network device CN; and the transmission unit 22 that is configured to transmits the request signal to the mobile station UE#1 and the mobile station UE#2 to measure the radio communication quality between the mobile station UE#1 and the mobile station UE#2 when the predetermined notification signal is received, wherein the reception unit 21 is configured to receive the measurement result of the RS#2 from the mobile station UE#1, and to receive a measurement result of the RS#1 from the mobile station UE#2, the transmission unit 22 is configured to notify the core network device CN that the mobile station UE#1 and the mobile station UE#2 start to transmit and receive the data signal without the radio base station eNB, the RS#1 is the reference signal that is transmitted to the mobile station UE#2 by the mobile station UE#1, and the RS#2 is a reference signal that is transmitted to the mobile station UE#1 by the mobile station UE#2.

In the fourth feature of the embodiment, the mobile station UE#1 includes: the reception unit 32 that is configured to receive the request signal from the radio base station eNB to measure the radio communication quality between the mobile station UE#1 and the mobile station UE#2 when the mobile station UE#1 is connected to the cell under the dominant of the radio base station eNB connected under the dominant of the core network device CN; the measurement unit 33 that is configured to perform the measurement (the measurement process) to the RS#2 transmitted by the mobile station UE#2 in response to the request signal; and the transmission unit 31 that is configured to transmit the measurement result of the RS#2 to the radio base station eNB, wherein the transmission unit 31 and the reception unit 32 are configured to start to transmit and receive the data signal to and from the mobile station UE#2 without the radio base station eNB in response to the instruction signal from the radio base station eNB.

The operations of the core network device CN, the radio base station eNB, the mobile station UE, and the like may be implemented by hardware, a software module executed by a processor, or a combination of thereof.

The software module may be provided in any storage medium such as a RAM (Random Access Memory), a flash memory, a ROM (Read Only Memory), an EPROM (Erasable Programmable ROM), an EEPROM (Electronically Erasable and Programmable ROM), a register, a hard disk, a removable disk, and a CD-ROM.

The storage medium is connected to the processor such that the processor can write and read information in and from the storage medium. The storage medium may be integrated in the processor. The storage medium and the processor may be provided in an ASIC. The ASIC may be provided in the core network device CN, the radio base station eNB, the mobile station UE, or the like. The storage medium and the processor may be provided in the core network device CN, the radio base station eNB, the mobile station UE, or the like as a discrete component.

Although the present invention is described in detail using the embodiment, it is clear for those skilled in the art that the present invention is not limited to the embodiment. Various corrections and changes can be made without departing from the scope of the present invention. Accordingly, the description is aimed only at the illustration, and the description has no restrictive meaning to the present invention.

### REFERENCE SIGNS LIST

CN core network device
eNB radio base station
UE mobile station
11, 21, 32 reception unit
12, 22, 31 transmission unit
13, 23 determination unit
33 measurement unit

1. A mobile communication method comprising:
a step in which a core network device transmits a predetermined notification signal to a radio base station when a first mobile station and a second mobile station are connected to a cell under a dominant of the identical radio base station;
a step in which the radio base station transmits a request signal to the first mobile station and the second mobile station to measure radio communication quality between the first mobile station and the second mobile station in response to the predetermined notification signal;
a step in which the first mobile station transmits a first reference signal to the second mobile station in response to the request signal;
a step in which the second mobile station transmits a second reference signal to the first mobile station in response to the request signal;
a step in which the first mobile station transmits a measurement result of the second reference signal to the radio base station; and
a step in which the second mobile station transmits a measurement result of the first reference signal to the radio base station.

2. The mobile communication method according to claim 1, further comprising a step in which the first mobile station and the second mobile station start to transmit and receive a data signal without the radio base station after the measurement results of the first reference signal and the second reference signal are transmitted.

3. A core network device to which a radio base station is connected under a dominant thereof, the core network device comprising:
a determination unit that is configured to determine whether a first mobile station and a second mobile station are connected to a cell under a dominant of the radio base station when service request signals are received from the first mobile station and the second mobile station;
a transmission unit that is configured to transmit a predetermined notification signal to the radio base station when the determination unit determines that the first mobile station and the second mobile station are connected to the cell under the dominant of the radio base station; and
a reception unit that is configured to receive a signal from the radio base station, the signal indicating that the first mobile station and the second mobile station start to transmit and receive the data signal without the radio base station.

4. A radio base station that is connected under a dominant of a core network device, the radio base station comprising:
a reception unit that is configured to receive a predetermined notification signal, which makes a notification that a first mobile station and a second mobile station are connected to a cell under a dominant of the radio base station, from the core network device; and
a transmission unit that is configured to transmit a request signal to the first mobile station and the second mobile station to measure radio communication quality between the first mobile station and the second mobile station when the predetermined notification signal is received,
wherein the reception unit is configured to receive a measurement result of a second reference signal from the first mobile station, and to receive a measurement result of a first reference signal from the second mobile station,
the transmission unit is configured to notify the core network device that the first mobile station and the second mobile station start to transmit and receive a data signal without the radio base station,
the first reference signal is a reference signal that is transmitted to the second mobile station by the first mobile station, and
the second reference signal is a reference signal that is transmitted to the first mobile station by the second mobile station.

5. A mobile station comprising:
a reception unit that is configured to receive a request signal from a radio base station to measure radio communication quality between the mobile station and the other mobile station when the mobile station is connected to a cell under a dominant of the radio base station connected under a dominant of a core network device;
a measurement unit that is configured to perform a measurement process to a reference signal transmitted by the another mobile station in response to the request signal; and
a transmission unit that is configured to transmit a measurement result of the reference signal to the radio base station,
wherein the transmission unit and the reception unit are configured to start to transmit and receive a data signal to and from the other mobile station without the radio base station in response to an instruction signal from the radio base station.
